(19) United States
(12) Patent Application Publication
(10) Pub. No.: US 2015/0018063 A1
(43) Pub. Date: Jan. 15, 2015

(54) ELECTRONIC CASINO CARD GAME

(71) Applicant: Andre' Osuch, Mesa, AZ (US)

(72) Inventor: Andre' Osuch, Mesa, AZ (US)

(21) Appl. No.: 13/942,272

(22) Filed: Jul. 15, 2013

(51) Int. Cl. G07F 17/32

(52) U.S. Cl. CPC G07F 17/3293; G07F 17/323
USPC 463/13

(57) ABSTRACT

A computer controlled electronic casino poker card game with two-phase betting in each of four rounds of betting per hand. First phase actions are one of check, bet, call, raise, or fold. Second phase actions are either call or fold. Each player gets one action per phase. The apparatus has a programmed processor communicatively coupled to a plurality of player stations that each provide touch-screen interactive displays for displaying two card images, action button images, betting account balance, and a timer. A centrally located game display screen displays up to three flop card images, first and second betting pot balance, and identity of the action button location. Collections for the rake are made after the ante and after each betting round in which the pot reaches a predetermined value. In an embodiment, the game display screen includes two identical outward-facing vertically-oriented game display screens between two straight opposed tables.

### FIELD OF THE INVENTION

This invention relates to computer controlled electronic five-card community casino poker games and more particularly to such poker games with single-action betting per flop.

### BACKGROUND

Poker is a popular gambling game that has many versions. Poker is conventionally played with a 52-card deck of cards in four suits (ranked Spades, Hearts, Diamonds, and Clubs, in descending order) and 13 cards in each suit (ranked Ace, King, Queen, Jack, 10, 9, 8, 7, 6, 5, 4, 3, 2, in descending order). The object of the game is to form a poker hand of higher rank than that held by any other player, or least make the other players think you have such a hand. Poker hands are ranked as Royal Flush, Straight Flush, Four Of A Kind (regardless or suit), Full House (a pair plus three of a kind, regardless of suit), Flush (all cards in same suit, Straight (a sequence in rank of cards, regardless of suit), Three Of A Kind (regardless of suit), Two Pairs (regardless of suit), One Pair (regardless of suit), and High Cards (no pattern). Cards are conventionally dealt from a hand-held deck. In other card games, such as Black-Jack, cards are dealt from a dealing shoe by sliding the card out of the dealing shoe and across the table to the player.

Community poker games, for example, Texas Hold'em, use a combination of cards dealt face down to each player and cards dealt face up in front of the dealer to form a poker hand. Each face-up card is called a “flop” and betting occurs at each flop. Texas Hold'em provides for two mandatory blind bets, or “blinds” which are mandatorily made by the two players to the left of the dealer button before cards are dealt. In a casino, where the deal does not rotate among players, the players obligated to place blinds are indicated by a “dealer button”, or button, that is a portable object laid on the table surface and that circulates clockwise one player at a time after each hand. The button is moved after each hand so that the players obligated to place blind bets change after each hand. The nearest person to the button on the left places a small blind, usually less than the minimum bet limit, and the second person from the dealer's left places the big blind, often equal to the minimum bet limit. Betting begins with the person to the left of the big blind. In Texas Hold'em, a “straddle” is permitted, which is a voluntary blind raise made after the blinds are placed and which reestablishes the point at which the betting begins as the position to the left of the straddle.

Casino poker is commonly played at an oval or kidney-shaped, table with nine players. In casinos, tournament play may include ten players per table.

The gaming world is constantly in search of faster moving and more profitable games.

Therefore, a need exists for a faster-moving and more profitable game. A need also exists for a poker game played on a table that easily accommodates ten players and is electronically instantiated. A need exists for a poker game that attracts players. A need exists for a community poker game without mandatory blinds. A need exists for a community poker game that limits the number of player actions per flop card. A need exists for a poker game that enables more hands to be played per hour.

### Objects and Features of the Invention

A primary object and feature of the present invention is to overcome the above-mentioned problems and fulfill the above-mentioned needs.

Another object and feature of the present invention is to provide a faster-moving community poker game. Another object and feature of the present invention is to provide a more profitable poker game for a casino. Another object and feature of the present invention is to provide a custom poker table for ten players. Another object and feature of the present invention is to provide a community poker game without mandatory blinds. Another object and feature of the present invention is to provide a community poker game that is dealt electronically. Another object and feature of the present invention is to provide a community poker game that enables more hands to be played per hour. Another object and feature of the present invention is to provide a community poker game that is faster than Texas Hold'em.

It is an additional primary object and feature of the present invention to provide community poker game that is economical, attractive, comfortable, and easy. Other objects and features of this invention will become apparent with reference to the following descriptions.

### SUMMARY OF THE INVENTION

In accordance with a preferred embodiment hereof, this invention provides an electronic casino poker card game that has a programmed processor communicatively coupled to a plurality of player video screens and one or more game display screens. The player video screens are preferably interactive touch screens. Each player video screen displays the card images dealt to the respective player in a traditional face-down orientation. Use of the touch screen feature reveals a useful portion of the face of the face-down card. Each player video screen also displays interactive button images for betting, calling, checking, folding, and raising, as well as showing the amount in the player's betting account. A timer may also be displayed on the players video screen. The game display screen displays the amount in the pot and the jackpot, as well as up to three flop cards. The player station position that has the action button may also be displayed on the game display screen.

The programmed processor implements a game that has four betting rounds (after ante and after each of three flop cards) of two phases each. In the first action phase, only one action from the list of betting, raising, calling, folding, and checking is allowed. In the second action phase, only one action from the list of calling and folding is allowed. The action button is initially randomly assigned and is moved one position to the left after each hand. The player to the left of the action button initiates each phase.

In a table embodiment, the player stations are arranged peripherally around a table and the game display screen is centrally located. Each player station has a player video screen, a position indicator that illuminates to indicate button position, and a money transferor for at least transferring money into the player's betting account. Preferably, the money transferor can also transfer winnings to the player.

The game display screen may be inset or flush with the table. In a particular table embodiment, the game display screen is vertically oriented and mounted on a support that optionally rotates in response to a motor controlled by the game processor. In a preferred variation of that embodiment, there are two opposed vertically mounted outwardly facing game display screens. In another preferred embodiment, the motor is controlled by the programmed processor to face a game display screen towards the player station that has the next action.

The connections between the player video screens, the game display screen, the rake account and the jackpot account may be hardwired or wireless and may be hardwired logic circuitry, intranet connections in which the player video screens, game display screen, rake account and jackpot account are addressable nodes on an intranet within the game table or among a plurality of game tables. In non-table preferred embodiment, the processor is on an Internet server, the player video screens are on personal computers that are nodes on the Internet, and the game display screen information is also displayed on the player video screens.

### BRIEF DESCRIPTION OF THE DRAWINGS

The above and other objects and advantages of the present invention will become more apparent from the following description taken in conjunction with the following drawings in which:

FIG. 1 is a top plan diagrammatic view illustrating an exemplary electronic casino card game, according to an exemplary embodiment of the present invention;

FIG. 2 is a top plan diagrammatic view illustrating an exemplary player video display of the exemplary electronic casino card game of FIG. 1, according to an exemplary embodiment of the present invention;

FIG. 3 is a diagrammatic view illustrating signal connections of the exemplary electronic casino card game of FIG. 1, according to an exemplary embodiment of the present invention;

FIG. 4 is a process flow diagram illustrating exemplary logical steps of the exemplary electronic casino card game of FIG. 1, according to an exemplary embodiment of the present invention;

FIG. 5 is a diagrammatic view illustrating a game screen of a second exemplary electronic casino card game, according to a second exemplary embodiment of the present invention;

FIG. 6 is a top plan diagrammatic view illustrating the second exemplary electronic casino card game of FIG. 5, according to an exemplary embodiment of the present invention;

FIG. 7 is a top plan diagrammatic view illustrating a third exemplary electronic casino card game, according to an exemplary embodiment of the present invention; and

FIG. 8 is a front elevation diagrammatic view illustrating anr exemplary embodiment of a game screen for the third exemplary electronic casino card game of FIG. 7, according to an exemplary embodiment of the present invention.

### DETAILED DESCRIPTION OF THE BEST MODES AND PREFERRED EMBODIMENTS OF THE INVENTION

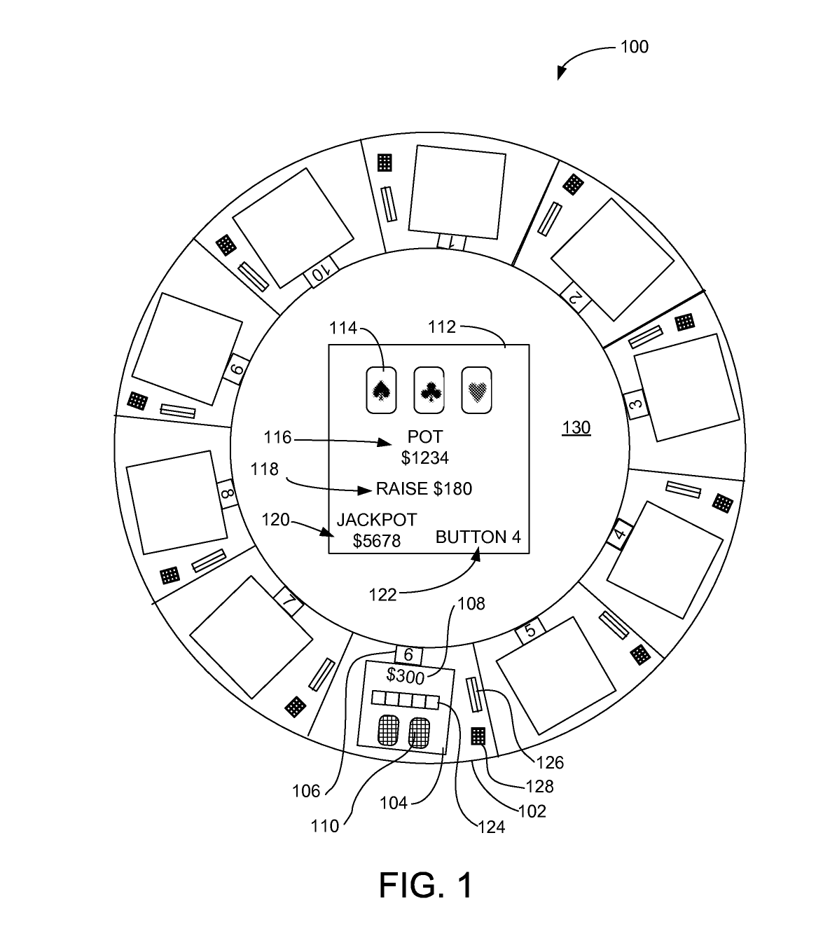

FIG. 1 is a top plan diagrammatic view illustrating an exemplary electronic casino card game 100, according to an exemplary embodiment of the present invention. Electronic card table 130 has ten player positions 102 (one of ten labeled) arranged peripherally. The round shape of table 130 is merely exemplary and is not a limitation of the invention. Each player position 102 includes a video touch screen 104 (one of ten labeled), as known in the art, that displays information and images and can respond to being touched by a player's hand or finger. On each player screen 104 is a money display 108 (one of ten labeled) of how much money the player has available for betting in that player's betting account. The money display 108 shows the net of all starting money, minus losses and plus wins and is updated at each bet by the player and at the end of each hand of poker. Starting money can be provided by means of a money transferor 126 (one of ten labeled), illustrated as a credit card reader, with the assistance of numeric keypad 128 (one of ten labeled). Any method of transferring money into the player's betting account may be used. Money transferor 126 may electronically receive money into the player's money display 108 and may assist in electronically transferring money from the game 100 to the player, personally. For example, if the player uses a particular credit card to add money to that player's betting account, the money transferor 126 may, at the end of the game, electronically transfer the player's winnings to that same credit card. Other devices for transferring money into or out of the game 100 may be used in various embodiments.

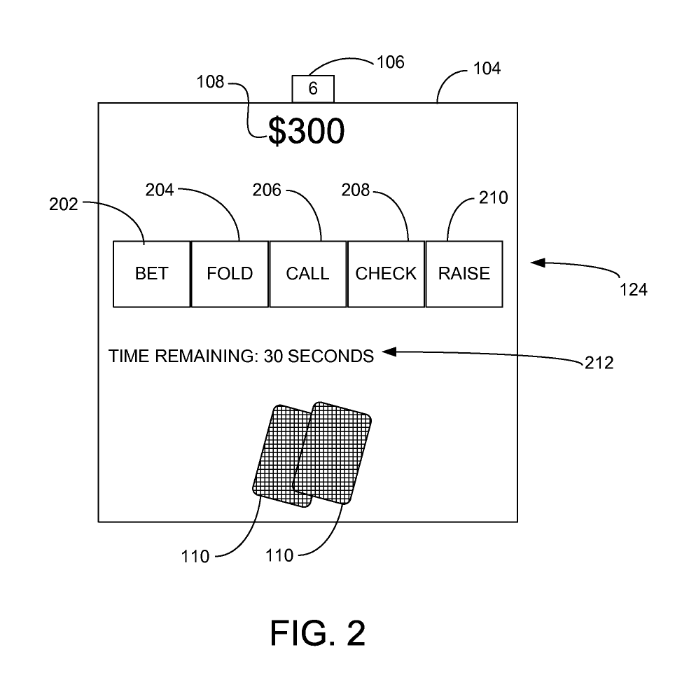

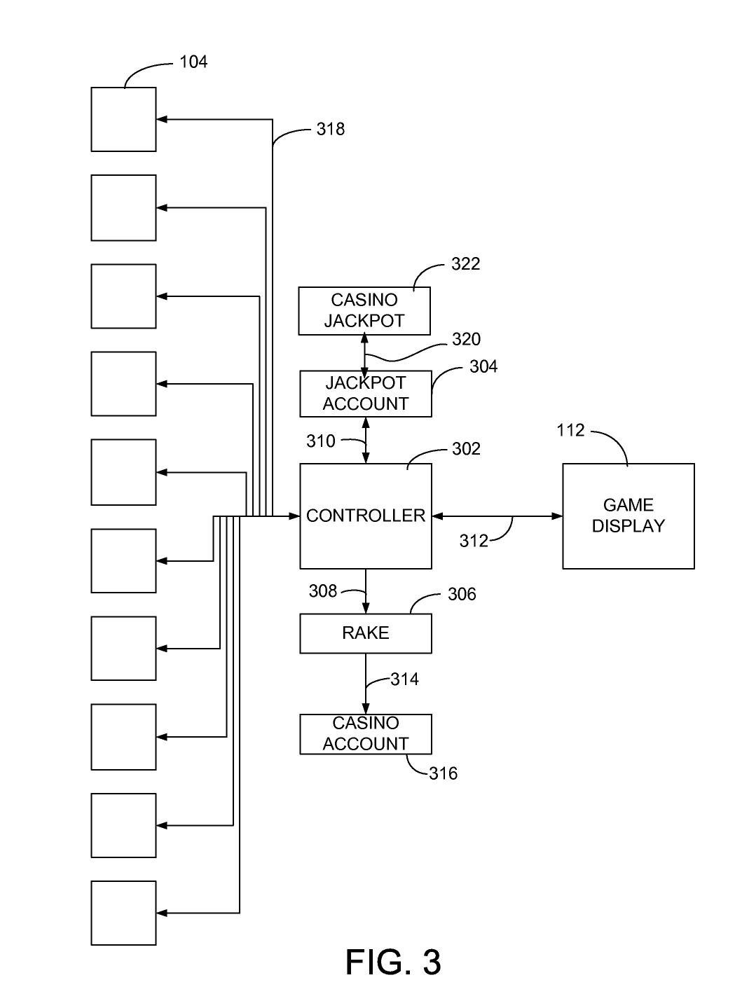

Player screen 104 displays two card images 110 (one of two labeled), face down, electronically dealt to the player by the game controller 302 (see FIG. 3). The player may view the faces of the cards 110 by placing the side of the player's hand across the cards 110, to which the game controller responds by showing enough of the cards 110 face images to enable the player to identify the cards 110. Player screen 104 also has a plurality of touch screen action buttons 124, which will be discussed in more detail in regard to FIG. 2. The shape of the player screen 104 is not a limitation of the invention.

Player station 102 also has a player number indicator 106 (one of ten labeled), which is visible to all players and which can be illuminated by the game controller 302 (see FIG. 3) to indicate the position of the action button.

Game screen 112, positioned in the middle of table 130, displays up to three flop cards 114 (one of three labeled), face up, as they are dealt by the game controller 302 (see FIG. 3). Game screen 112 also displays the current value of the pot 116, the current value of the raise 118, the amount of the jackpot 120, and the current player position 122 of the action button.

In an additional embodiment, flop card images 114 may also be displayed on player screens 104. The shape of the game screen 112 is not a limitation of the invention.

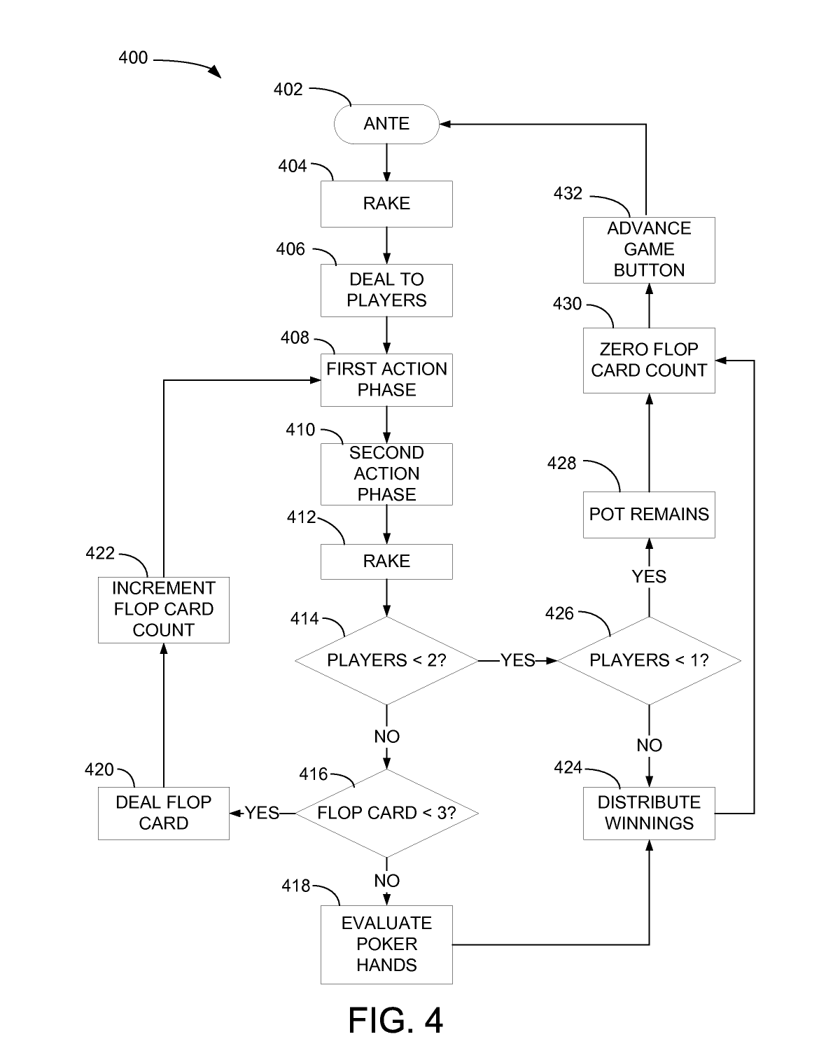

FIG. 2 is a top plan diagrammatic view illustrating an exemplary player video display 104 of the exemplary electronic casino card game 100 of FIG. 1, according to an exemplary embodiment of the present invention. Five exemplary action buttons 202, 204, 206, 208, and 210 are touch screen buttons. First action button 202, or bet button 202, is touched to make a bet 408 (see FIG. 4) or an ante 402 (see FIG. 4). A minimum bet 408 may be programmed into game controller 302 (see FIG. 3). In a particular embodiment, all bets 408 may be multiples of the minimum bet 408. In a preferred embodiment, the amount of any bet or raise is predetermined. For example, any bet or raise is $3.00. In another preferred embodiment, the amount of any bet or raise has first and second predetermined values. For example, a low bet of $3.00 and a high bet of $6.00. In another preferred embodiments, the player may communicate the amount of his bet through the numeric keypad 128, through a keypad display on the player's touch screen 104, or through use of the third action button 206, or call button 206, which will allocate the correct amount of money needed to call the poker hand. Second action button 204, or fold button 204, folds the player's poker hand and removes his card images 110 from his screen. Fourth action button 208, or check button 208, uses the player first phase action 408 without betting. Fifth action button 210, or raise button 210, raises the previous bet by an amount determined by the player, within the constraint of any minimum or maximum bet. Not all actions are available at all times during the game. When a particular action is not available, the button corresponding to that action may be dimmed or, in some embodiments, may not be displayed at all. For example, the raise button 210 is not available as a second phase action, and so may be dimmed during the second phase. The shape, sequence, and arrangement of the action buttons 202, 204, 206, 208, and 210 are not limitations of the present invention. Player screen 104 may also display a timer 212 to prod the player into prompt action. A buzzer may be provided to indicate an overtime condition.

FIG. 3 is a diagrammatic view illustrating signal connections of the exemplary electronic casino card game 100 of FIG. 1, according to an exemplary embodiment of the present invention. Game controller 302 is communicatively coupled via links 318 (one of ten labeled) to player touch screens 104 to send video and logical signals to player screens 104 and to receive data from player touch screens 104. In particular embodiments, game controller 302 may also be communicatively coupled to money transferor 126. Game controller 302 includes a processor that is programmed to implement at least the logic of FIG. 4 to operate the exemplary electronic casino card game 100. The links 320, 318, 312, 308, and 314 may be hardwired or wireless and may use a local intranet protocol for addressing each individual player screen 104 and the game display 112. In the illustrated embodiment, game controller 302 operates the table jackpot account 304 via link 310. The table jackpot account 304 periodically transfers to the casino-wide jackpot account 322 over link 320 and can distribute the money in the casino-wide jackpot account 322 to players over links 320, 310, and 318. Game controller 302 transfers money to the rake 306 account over one-way link 308 and can transfer the rake 306 to casino rake account 316 over one-way link 314 in accordance with a preprogrammed casino policy in game controller 302. Game controller 302 is communicatively linked with game display 112 over link 312 to supply video signals and data to game display 112 and to receive feedback data from game display 112.

In a particular embodiment, game controller 302 may be implemented in software on a server and may supply game controller services to a plurality of exemplary electronic casino card games 100 via intranet or internet connections. In an internet embodiment, player stations 102 may be internet-connected personal computers, in various locations, with equivalent functionality as to screen display and money transfer.

FIG. 4 is a process flow diagram illustrating exemplary logical steps 400 of the exemplary electronic casino card game 100 of FIG. 1, according to an exemplary embodiment of the present invention. The position of the action button 122 is randomly assigned before step 402. The game 100 begins in step 402 with an ante from each player, made by pressing the bet button 202. A portion of the ante pot is raked 404 for the casino. The game controller 302 deals two cards (creates two card images 110) to each player's touch screen 104 in step 406. In step 408, the first phase action of the first betting round begins with the player to the left of the action button position 122 and proceeds, in turn, to the left until all players have had an opportunity to check 208, bet 202, call 206, fold 204, or raise 210, which are the actions allowed in the first action phase 408. All raising ends with the last player (who has the action button 106) in the first action phase 408. The second action phase 410 of the first betting round begins with the player to the left of the action button position 122 and proceeds, in turn, to the left until all players have had an opportunity to call 206 or fold 204, which are the only actions allowed in the second action phase 410.

In step 412, the game controller 302 takes from the pot portions for the rake 306. In step 414, the game controller 302 determines if there are less than two players left at the end of the second phase 410. If so, the game controller 302 determines if there are no players left in step 426. This is an unheard of event, but must be included in a computerized game for logics 1 completeness. If there are no players left, the game controller 302 leaves the pot on the table in step 418 and proceeds toward the next hand. In step 430, the count of the number of flop cards 114 that have been dealt, which is used in step 416, is set to zero. Then in step 432, action button position 122 is advanced one player position 102 to the left to begin the next hand. In an additional embodiment, the absence of players at the end of step 410 may not terminate the poker hand, but may simply lead to the dealing of the next flop card 114, if less than three flop cards 114 have been dealt. After step 432, the next hand starts at step 402 with the ante.

Going back to decision 426, if there is only one player left, the game controller 302 distributes the winnings in step 424 to the last player in the game, and transfers control to step 430, as previously described. Going back to decision 414, if there are two or more players remaining, step 416 determines if less than three flop cards 114 have been dealt. If not, the game controller 302 evaluates the poker hands held by each remaining player and determines the winner. Then, control transfers to step 424, as previously described. The game controller 302 reads the flop card counter (a software device) to determine if less than three flop cards 114 have been dealt. If so, the game controller 302 deals 420 a flop card 114 by presenting its image on game screen 112. In the next step 422, the flop card counter is incremented by one and control is transferred to step 408 for the next betting round. The loop 408, 410, 412, 414, 416, 420, and 422 continues to repeat until either there are less than two players left 414 or all three flop cards 114 have been dealt 416.

In particular embodiments, more betting features may be added. For example, blind bets (mandatory or voluntary), and straddles, may be added. For further example, criteria for winning the jackpot, or promotional account, depending on the particular casino, may be programmed into the game controller 302 and may be displayed on the game screen 112.

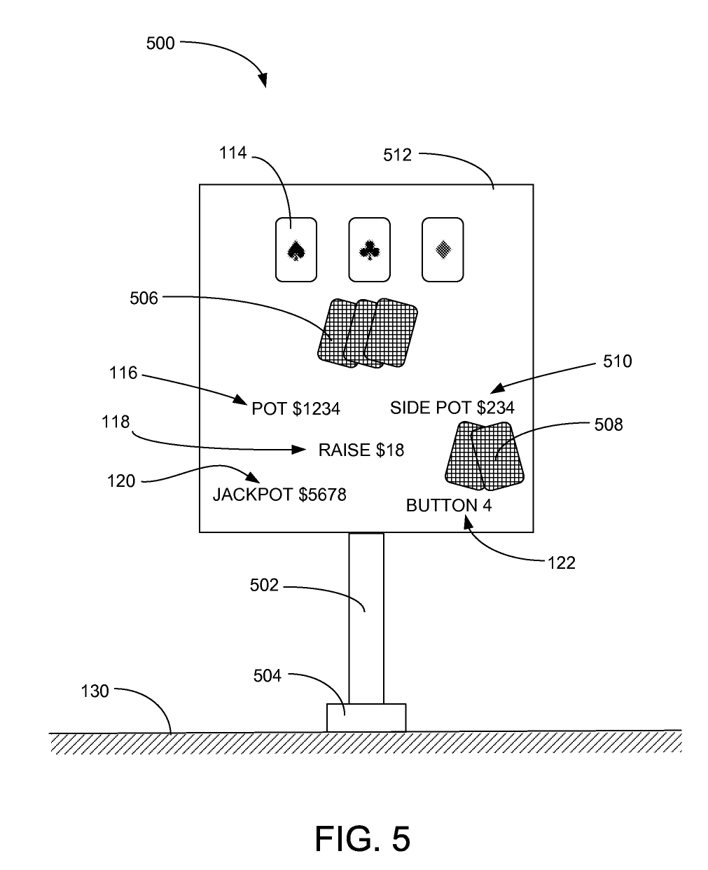

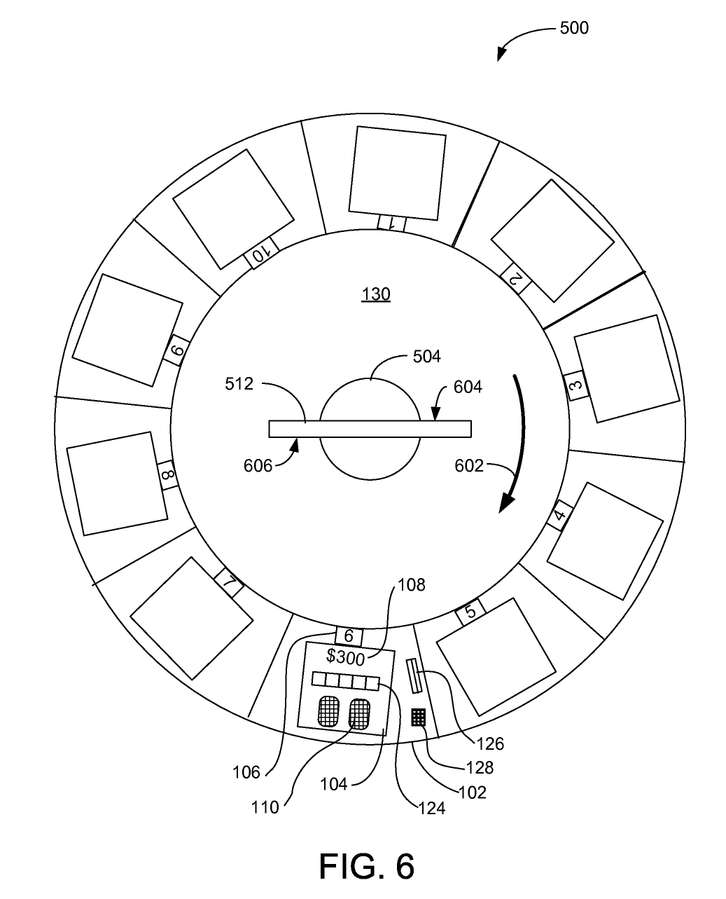

FIG. 5 is a diagrammatic view illustrating a game screen 512 of a second exemplary electronic casino card game 500, according to a second exemplary embodiment of the present invention. Exemplary electronic casino card game 500 is the same as exemplary electronic casino card game 100, except that the game screen 512 is double sided, oriented vertically, supported by support 502 about eighteen inches above the poker table 130, and optionally rotates 602 (see FIG. 6) slowly responsive to an electric motor 504. The displays on the first and second sides 604 and 606 (see FIG. 6) are identical. In a particular embodiment, the game controller 302 may be programmed to rotate the game screen 512 to rotate to face the player whose turn is in progress. In addition to the features illustrated in FIG. 1, game screen 512 includes burn card images 506, muck card images 508, and a side pot image 510.

FIG. 6 is a top plan diagrammatic view illustrating the second exemplary electronic casino card game 500 of FIG. 5, according to an exemplary embodiment of the present invention. Game screen 512 has displays like game screen 112 on both sides 604 and 606. Rotation 602 of game screen 512 provides ample viewing time for all players.

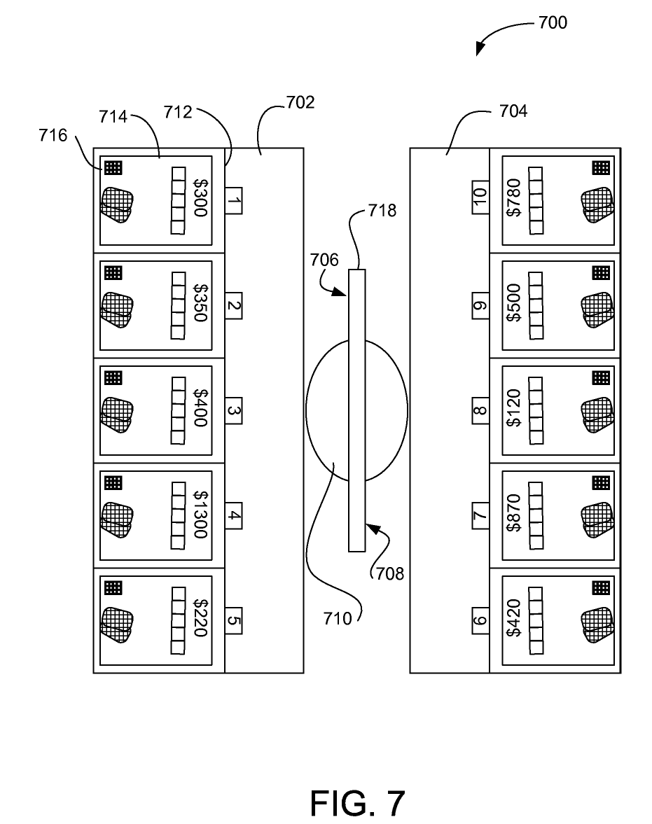

FIG. 7 is a top plan diagrammatic view illustrating a third exemplary electronic casino card game 700, according to an exemplary embodiment of the present invention. Third exemplary electronic casino card game 700 includes first and second rectangular opposed spaced-apart tables 702 and 704 each supporting five player stations 712 (one of ten labeled). Each player station 712 includes a player's touch screen 714 that is similar to player screen 104. A touch screen numeric keypad 716 is illustrated in this embodiment. Game screen 718 is positioned between first and second tables 702 and 704. Game screen 718 has identical displays on first and second sides 706 and 708 and is supported, in a manner similar to game screen 512, on base 710. The electronic communications for the third exemplary electronic casino card game 700 is similar to that illustrated in FIG. 3.

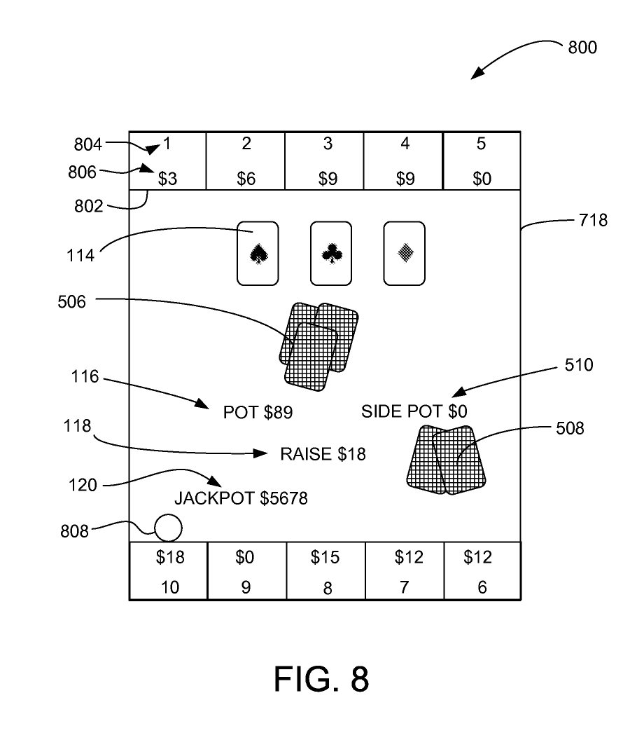

FIG. 8 is a front elevation diagrammatic view illustrating and exemplary embodiment 800 of a game screen 718 for the third exemplary electronic casino card game 700 of FIG. 7, according to an exemplary embodiment of the present invention. In addition to features illustrated in FIG. 1 and FIG. 5, game screen 718 displays representations 802 (one of ten labeled) of each player's number and current bet. Each representation 802 includes the player's number 804 and that player's current bet 806. The action button image 808 moves leftward (ascending player number 804 order) after each hand.

An advantage of the present invention is that it is faster than Texas Hold'em, allowing the casino to earn more money per table per hour. Another advantage of the present invention is that it provides simplified betting, as each round is limited to two actions per player. Yet another advantage is its attractiveness to players. The present invention is also advantageously easy to learn for all skill levels. The present invention advantageously puts more players in action every round. The present invention advantageously can be played with no small or big blinds. The present invention advantageously is easy to learn for management.

I claim:

1. An electronic poker card game with for a plurality of players, wherein a player is a person who has paid an ante and has not folded and wherein such plurality of players may be reduced during play, the game comprising:
a. a programmable controller having a processor programmed to implement said electronic poker card game;
b. a plurality of player stations each comprising an interactive touch screen communicatively each coupled to said processor; and
c. a game display screen communicatively coupled to said processor.

2. The electronic game of claim 1, comprising a table further comprising said plurality of player stations arranged sequentially and peripherally on said table.

3. The electronic game of claim 2, comprising said game display screen positioned centrally on said table.

4. The electronic game of claim 3, wherein said game display screen comprises two oppositely facing game display screens that are vertically oriented on a support.

5. The electronic game of claim 4, wherein said support comprises a motor that is controllable by said processor to ensure said game display screen is facing a player station of said plurality of player stations that is due to take action.

6. The electronic game of claim 1, wherein said game display screen is operable to display:
a. a plurality of flop card images;
b. a plurality of burn card images;
c. a plurality of muck card images;
d. an identifier of a said player station of said plurality of player stations that is currently assigned an action button;
e. an amount of money in a first betting pot;
f. an amount of money in a second betting pot; and
g. an amount of money in a jackpot account.

7. The electronic game of claim 1, wherein each said player station of said plurality of player stations comprises a money transferor, operable at least to transfer money into a player's betting account in said game.

8. The electronic game of claim 2, wherein each said player station further of said plurality of player stations comprises a numbered display showing a unique player station number and capable of internal illumination to indicate the location of a action button.

9. The electronic game of claim 1, wherein said processor comprises a processor programmed to implement the steps of:
a. randomly assigning a player station of said plurality of player stations as the position of a action button and initializing a flop card count to zero;
b. collecting an ante from each said player's betting account of said plurality of player betting accounts to form an ante pot;
c. collecting a portion of said ante pot for a rake;
d. displaying two unique poker playing card images, face down, on each screen of each said player station of said plurality of player stations;
e. displaying at least a portion of a face image of each said face down card if a player lays a side of said player's hand across said card image; and
f. beginning with a player station of said plurality of player stations that is immediately left of said position of said action button and proceeding leftward in sequence through each said player station of said plurality of player stations:
i. receiving one first phase action from each said player station, wherein said first phase action comprises one of betting, checking, or raising to form a betting pot; and
ii. after all first phase actions have been taken, receiving, proceeding leftward in sequence through each said player station of said plurality of player stations, one second phase action from each said player station, wherein said second phase action comprises one of calling and folding;
g. collecting a portion of said betting pot for a rake;
h. determining if there are less than two said player stations of said plurality of player stations that have not folded;
i. if not, determining if said flop count is less than three; and
1. if not, determining a winner, distributing the winnings to said winner, zeroing the flop count, advancing the action button one position leftward, and collecting antes for a next hand of said game; and
2. if so, dealing a flop card by displaying an image of a flop card on said game screen, incrementing the flop count by one, and returning to step “f” for additional betting;
ii. if so, determining if there is less than one said player station of said plurality of player stations that has not folded;
1. if not, distributing the winnings to the remaining said player station of said plurality of player stations, zeroing the flop count, advancing the action button one position leftward, and collecting antes for a next hand of said game;
2. if so, zeroing the flop count, advancing the action button one position leftward, and collecting antes for a next hand of said game.

10. The electronic game of claim 1, wherein said interactive touch screen is operable to display:
a. an amount of money in a player's betting account;
b. two interactive poker playing card images showing cards face down but operable by player's touch to show at least a portion of a face image of each said interactive poker playing card image of said two interactive poker playing card images.
c. an interactive action button image, operable to pay an ante from said player's betting account and to make a bet from said player's betting account;
d. an interactive folding button image, operable to fold the poker hand and erase said playing card images from said screen;
e. an interactive calling button image, operable to place a bet from said player's betting account that is adequate to cover any raise previously made;
f. an interactive checking button image, operable to bet nothing in first phase action; and
g. an interactive raising button image, operable to raise a previous bet made by another player by placing a raise from said player's betting account; and
h. a timer, operable to show said player a preferred time remaining in which to take action.

11. The electronic game of claim 1, further comprising:
a. a rake account operated by said processor and operable to receive a first portion of bets and antes made from said player stations of said plurality of player stations and to transfer said first portion of bets and antes to a casino account, responsive to a signal from said processor;
b. a promotional rake account operated by said processor and operable to receive a second portion of bets and antes made from said player stations of said plurality of player stations and to transfer said promotional rake to a central promotional account for an entire casino; and
c. wherein said processor is further operable to distribute said central promotional account to a players betting accounts when predetermined criteria for winning said promotional account have been met.

12. The electronic game of claim 1, wherein said processor comprises a processor resident on a server on an intranet, said plurality of player station screens comprise addressable nodes on said intranet, and said game display screen comprises an addressable node on said intranet.

13. The electronic game of claim 1, wherein said processor comprises a processor resident on a server on the Internet, said plurality of player station screens comprise addressable nodes on said Internet, and said game display screen comprises an addressable node on said Internet.

14. An electronic poker card game with for a plurality of players, wherein a player is a person who has paid an ante and has not folded and wherein such plurality of players may be reduced during play, the game comprising:
a. a programmable controller having a processor programmed to implement said electronic poker card game;
b. a plurality of player stations each comprising an interactive touch screen communicatively each coupled to said processor;
c. a game display screen communicatively coupled to said processor; and
d. wherein said interactive touch screen is operable to display:
i. an amount of money in a player's betting account;
ii. two interactive poker playing card images showing cards face down but operable by player's touch to show at least a portion of a face image of each said interactive poker playing card image of said two interactive poker playing card images.
iii. an interactive action button image, operable to pay an ante from said player's betting account and to make a bet from said player's betting account;
iv. an interactive folding button image, operable to fold the poker hand and erase said playing card images from said screen;
v. an interactive calling button image, operable to place a bet from said player's betting account that is adequate to cover any raise previously made;
vi. an interactive checking button image, operable to bet nothing in first phase action; and
vii. an interactive raising button image, operable to raise a previous bet made by another player by placing a raise from said player's betting account; and
viii. a timer, operable to show said player a preferred time remaining in which to take action.

15. The electronic game of claim 14, wherein said processor is programmed to implement the steps of:
a. randomly assigning a player station of said plurality of player stations as the position of a action button and initializing a flop card count to zero;
b. collecting an ante from each said player station of said plurality of player stations to form an ante pot;
c. collecting a portion of said ante pot for a rake;
d. displaying two unique poker playing card images, face down, on each screen of each said player station of said plurality of player stations;
e. displaying at least a portion of a face image of each said face down card if a player lays a side of said player's hand across said card image; and
f. beginning with a player station of said plurality of player stations that is immediately left of said position of said action button and proceeding leftward in sequence through each said player station of said plurality of player stations:
i. receiving one first phase action from each said player station, wherein said first phase action comprises one of betting, checking, or raising to form a betting pot; and
ii. after all first phase actions have been taken, receiving, proceeding leftward in sequence through each said player station of said plurality of player stations, one second phase action from each said player station, wherein said second phase action comprises one of calling and folding;
g. collecting a portion of said betting pot for a rake and another portion of said betting pot for a jackpot;
h. determining if there are less than two said player stations of said plurality of player stations that have not folded;
i. if not, determining if said flop count is less than three; and
1. if not, determining a winner, distributing the winnings to said winner, zeroing the flop count, advancing the action button one position leftward, and collecting antes for a next hand of said game; and
2. if so, dealing a flop card by displaying an image of a flop card on said game screen, incrementing the flop count by one, and returning to step “f” for additional betting;
ii. if so, determining if there is less than one said player station of said plurality of player stations that has not folded;
1. if not, distributing the winnings to the remaining said player station of said plurality of player stations, zeroing the flop count, advancing the action button one position leftward, and collecting antes for a next hand of said game;
2. if so, distributing said betting pot into said rake and said jackpot, zeroing the flop count, advancing the action button one position leftward, and collecting antes for a next hand of said game.

16. The electronic game of claim 14, wherein said game display screen is operable to display:
a. a plurality of flop card images;
b. a current said player station of said plurality of player stations that is assigned a action button;
c. an amount of money in a betting pot; and
d. an amount of money in a jackpot account.

17. The electronic game of claim 14, wherein said processor comprises one of:
a. a processor resident on a server on an intranet, said plurality of player station screens comprise addressable nodes on said intranet, and said game display screen comprises an addressable node on said intranet;
b. a processor resident on a server on the Internet, said plurality of player station screens comprise addressable nodes on said Internet, and said game display screen comprises an addressable node on said Internet.

18. The electronic game of claim 14, comprising:
a. a table further comprising said plurality of player stations arranged sequentially and peripherally on said table; and
b. said game display screen positioned centrally on said table.

19. The electronic game of claim 14, wherein said game display screen comprises one of two oppositely facing game display screens that are vertically oriented on a support, wherein said support is operable to rotate via a motor and wherein said motor is controllable by said processor to ensure said game display screen is facing a player station of said plurality of player stations that is due to take action.

20. An electronic poker card game with for a plurality of players, wherein a player is a person who has paid an ante and has not folded and wherein such plurality of players may be reduced during play, the game comprising:
a. a programmable controller having a processor programmed to implement said electronic poker card game;
b. a plurality of player stations each comprising an interactive touch screen communicatively each coupled to said processor;
c. a game display screen communicatively coupled to said processor; and
d. wherein said interactive touch screen is operable to display:
i. an amount of money in a player's betting account;
ii. two interactive poker playing card images showing cards face down but operable by player's touch to show at least a portion of a face image of each said interactive poker playing card image of said two interactive poker playing card images.
iii. an interactive action button image, operable to pay an ante from said player's betting account and to make a bet from said player's betting account;
iv. an interactive folding button image, operable to fold the poker hand and erase said playing card images from said screen;
v. an interactive calling button image, operable to place a bet from said player's betting account that is adequate to cover any raise previously made;
vi. an interactive checking button image, operable to bet nothing in first phase action; and
vii. an interactive raising button image, operable to raise a previous bet made by another player by placing a raise from said player's betting account; and
viii. a timer, operable to show said player a preferred time remaining in which to take action;
e. wherein said processor is programmed to implement the steps of:
i. randomly assigning a player station of said plurality of player stations as the position of a action button and initializing a flop card count to zero;
ii. collecting an ante from each said player station of said plurality of player stations to form an ante pot;
iii. collecting a portion of said ante pot for a rake and another portion of said ante pot for a jackpot;
iv. displaying two unique poker playing card images, face down, on each screen of each said player station of said plurality of player stations;
v. displaying at least a portion of a face image of each said face down card if a player lays a side of said player's hand across said card image; and
vi. beginning with a player station of said plurality of player stations that is immediately left of said position of said action button and proceeding leftward in sequence through each said player station of said plurality of player stations:
1. receiving one first phase action from each said player station, wherein said first phase action comprises one of betting, checking, or raising to form a betting pot; and
2. after all first phase actions have been taken, receiving, proceeding leftward in sequence through each said player station of said plurality of player stations, one second phase action from each said player station, wherein said second phase action comprises one of calling and folding;
vii. collecting a portion of said betting pot for a rake and another portion of said betting pot for a jackpot;
viii. determining if there are less than two said player stations of said plurality of player stations that have not folded;
1. if not, determining if said flop count is less than three; and
a. if not, determining a winner, distributing the winnings to said winner, zeroing the flop count, advancing the action button one position leftward, and collecting antes for a next hand of said game; and
b. if so, dealing a flop card by displaying an image of a flop card on said game screen, incrementing the flop count by one, and returning to step “f” for additional betting;
2. if so, determining if there is less than one said player station of said plurality of player stations that has not folded;
a. if not, distributing the winnings to the remaining said player station of said plurality of player stations, zeroing the flop count, advancing the action button one position leftward, and collecting antes for a next hand of said game;
b. if so, distributing said betting pot into said rake and said jackpot, zeroing the flop count, advancing the action button one position leftward, and collecting antes for a next hand of said game;
f. wherein said game display screen is operable to display:
i. a plurality of flop card images;
ii. a current said player station of said plurality of player stations that is assigned a action button;
iii. an amount of money in a betting pot; and
iv. an amount of money in a jackpot account.
g. wherein said processor comprises one of:
i. a processor resident on a server on an intranet, said plurality of player station screens comprise addressable nodes on said intranet, and said game display screen comprises an addressable node on said intranet;
ii. a processor resident on a server on the Internet, said plurality of player station screens comprise addressable nodes on said Internet, and said game display screen comprises an addressable node on said Internet.
